(19) United States
(12) Patent Application Publication
(10) Pub. No.: US 2008/0103421 A1
(43) Pub. Date: May 1, 2008

(54) MASSAGE IMPLEMENT

(76) Inventor: Randy NICHOLSON, Marietta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/924,366

(22) Filed: Oct. 25, 2007

Related U.S. Application Data
(60) Provisional application No. 60/862,908, filed on Oct. 25, 2006.

(51) Int. Cl. A61H 15/00; A61H 7/00

(52) U.S. Cl. 601/120; 601/134; 601/137

(57) ABSTRACT

A massage implement including a central axle, at least one handle coupled to the central axle, and a plurality of rollers. The rollers are rotatably mounted to the central axle and can engage the area a user wishes to massage. A user can apply pressure to the at least one handle and move the rollers over the area to be massaged.

### CROSS-REFERENCE TO RELATED APPLICATIONS

This application claims priority to provisional application Ser. No. 60/862,908, entitled MASSAGE IMPLEMENT, filed on Oct. 25, 2006, which is incorporated herein by reference in its entirety.

### TECHNICAL FIELD OF THE INVENTION

The present invention relates generally to the field of massage, and more particularly, to an implement that can be used to administer massages.

### BACKGROUND OF THE INVENTION

Exercising is very beneficial to the human body. There are numerous ways that people exercise to keep their bodies in shape, such as running, cycling, swimming, weightlifting, etc. However, after a person exercises, their bodies release lactic acid and toxins into the cells of muscles that were exercised. These toxins can cause muscle soreness and fatigue. Exercising can also create tiny tears in the muscle fibers that develop scar tissue when they heal. Eventually, the accumulation of scar tissue can become painful. Moreover, these conditions apply to many other species of animals as well as humans, for example, horses, cows, dogs, cats, etc.

Often people (or other animals) injure their muscles more severely, whether through exercising, at work, or just through normal day-to-day activities. These types of muscle injuries often require rehabilitation to facilitate muscle healing. Other people routinely suffer from chronic joint pain or mobility problems that are created by shortened muscle fibers. It has been known that massage can be very therapeutic to injured muscles and can help relieve mobility problems caused by shortened muscle fibers. Massage therapy can increase blood flow to muscle tissue, lengthen muscle fibers, break up scar tissue, and alleviate muscle and joint pain. Known massage implements often only massage muscle tissue near the surface of the skin and are unable to engage deep muscle tissue. For example, a commonly used massage implement known commercially as the “stick” uses a plurality of cylindrical rollers to massage shallow muscle tissue. However, because of the cylindrical nature of the rollers, a user is not able to “dig” into the underlying deep muscle tissue to increase blood flow, release lactic acid, and/or alleviate scar tissue therein.

Thus it can be seen that needs exist for improvements to massage implements that are capable of massaging shallow and deep muscle tissue while releasing lactic acid and other toxins from the muscle tissue. Needs further exist for a massage implement that is capable of breaking up scar tissue in muscle fibers. It is to the provision of these needs and others that the subject matter of the present invention is directed.

### SUMMARY OF THE INVENTION

The present invention solves previous problems with known massage tools by having a plurality of substantially spherical rotatable rollers carried on an axle for massaging a subject. In example forms, the present invention is a massage implement including an elongated central axle, at least one handle coupled to the central axle, and a plurality of rollers. The rollers are generally spherical and are rotatably coupled to the central axle. Each of the rollers are operable to rotate independently of the other rollers. A user can apply pressure to the at least one handle and move the rollers over the area to be massaged. Optionally, the plurality of rollers can include five rollers. In additional forms, the plurality of rollers can be substantially the same size and shape. In still other forms, the plurality of rollers can be different sizes and/or shapes. The massage implement of the present invention permits a user to “dig” into muscle tissue to help lengthen the muscle fibers, remove scar tissue, alleviate trigger points, increase blood flow to the area, and increase muscle flexibility.

In another aspect, the present invention is a massage implement for massaging human or animal subjects. The implement includes an elongated rod having a first end and a second end. A first handle is coupled to the first end, and a second handle is coupled to the second end. The implement also includes a plurality of balls rotationally mounted to the rod between the first and second handles.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of a massage implement according to a first example embodiment of the present invention.

FIG. 2 is a partially exploded perspective view of the massage implement of FIG. 1.

FIG. 3 is a perspective view of a massage implement according to a second example embodiment of the present invention.

FIG. 4 is a perspective view of a massage implement according to a third example embodiment of the present invention.

FIG. 5 is a perspective view of a massage implement according to a fourth example embodiment of the present invention.

FIG. 6 is a perspective view of a massage implement according to a fifth example embodiment of the present invention.

FIG. 7 is a perspective view of a massage implement according to a sixth example embodiment of the present invention.

FIG. 8 is a front view of a massage implement according to a seventh example embodiment of the present invention.

### DETAILED DESCRIPTION OF THE PREFERRED EMBODIMENT

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

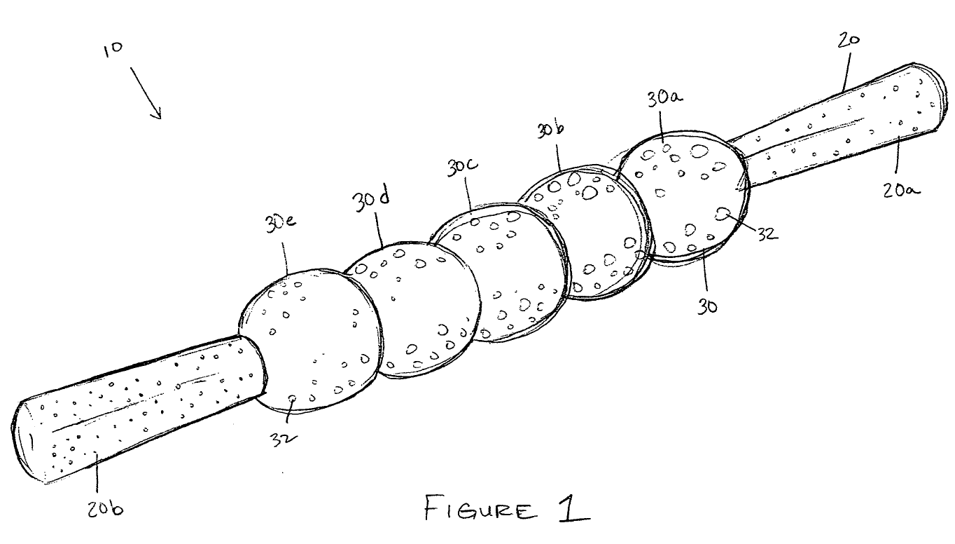

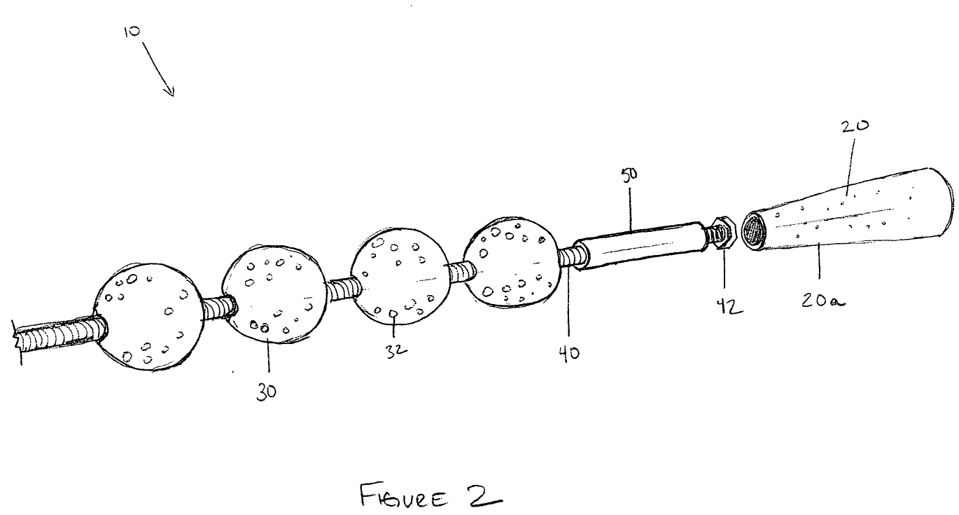

With reference now to the drawing figures, FIGS. 1-2 depict a massage implement 10 according to an example embodiment of the present invention. The massage implement 10 can be used to massage deep and shallow muscle tissue while stripping the muscle of scar tissue. The massage implement 10 can also alleviate muscle pain by relieving myofascial trigger points within the muscle tissue and/or by releasing lactic acid and other toxins from a person's muscle. By routinely utilizing the massage implement 10 to massage a muscle area, blood flow to the particular muscle may be increased, thereby allowing for faster healing times after exercising or after experiencing a muscle injury. As such, the massage implement 10 can be utilized in physical therapy, muscle rehabilitation, massage therapy, along with patients diagnosed with degenerative muscular diseases and/or arthritis. The massage implement 10 can also be used to “warm-up” muscles before engaging in exercise. The massage implement 10 can be self-administered or a user can administer the massage implement on a second person or even a pet or other animal. Generally, the massage implement 10 of the present invention includes at least one handle 20, at least one ball or roller 30, and a central support axle 40. The overall length of the massage implement 10 can vary with the particular application, but generally, the massage implement is between 12 and 24 inches. However, the massage implement 10 can be shorter than 12 inches, or greater than 24 inches in length. In commercial embodiments, the massage implement is about 15 inches in length.

A massage implement 10 according to a first example embodiment of the present invention is shown in FIGS. 1-2. In such embodiments, the implement 10 has two handles 20a, 20b on distal ends of the axle 40 for the user to hold onto when administering a massage. The handles 20a, 20b can have frictional gripping surfaces, such as those used with golf club grips. In commercial embodiments, five balls or rollers 30 (30a-e) are rotationally carried on the axle 40. In alternate example embodiments, more or fewer balls are used depending on the specific application and overall length of the implement 10. It has been found that five rollers 30 have been found to be particularly suitable for use with massage. However, it should be noted that nothing in this specification should be construed as limiting the number of balls or rollers 30 to any particular number, as the number of rollers can vary widely.

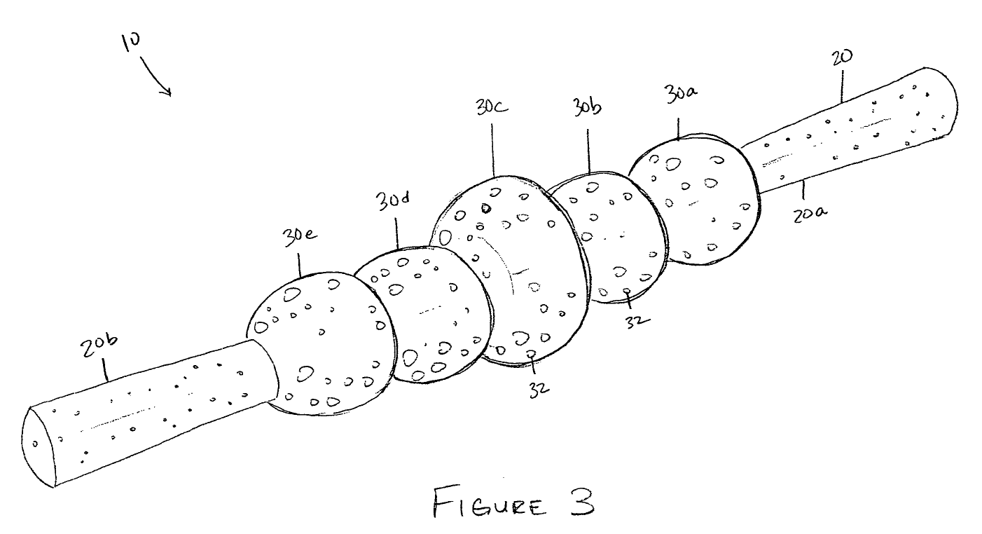

As seen in FIG. 2, the balls or rollers 30 rotate on the central support axle 40, which extends through bores passing through the center of the rollers. To ease the rotation of the rollers 30 about the axle 40, bearings can be used between the rollers and the axle. The rollers 30 can be spherical, elliptical, cylindrical, or other rounded three-dimensional shapes. Alternatively, the rollers can be pointed or have multiple protrusions. In commercial embodiments, it has been found that rollers 30 having a spherical shape are very effective. The use of the spherical rollers 30 has been found to allow for better traction on human/animal skin without ripping out hair or sliding along the skin, instead of rolling. The rounded rollers 30 also provide deeper muscle penetration and pressure on deep muscle tissue. The size of the rollers 30 can vary with the application, and can range from about ½ inch in diameter to 3 or more inches in diameter. The hardness of the rollers 30 can range from soft and flexible to hard and dense depending on the particular needs of the user. In preferred example embodiments, rollers having the shape, hardness and dimensions of a golf ball have been found to be particularly effective, wherein the rollers are approximately 1.7 inches in diameter and weigh approximately 1.6 ounces. Indeed, modified golf balls have been found suitable for use as the rollers 30 in example embodiments. In example embodiments, the rollers 30 are all identical. Alternatively, the center roller 30c can be larger than the other rollers, such that a user can concentrate pressure on a centralized area of the massage implement 10 as seen in FIG. 3. In still other alternate embodiments, one or more rollers 30 are different sizes. In additional embodiments, the rollers 30 can be interchangeable such that a user can utilize a particular combination of rollers having the desired size, hardness, and number of rollers. It has also been found that applying dimples 32 or other types of frictional surfaces to the face of the rollers 30 helps the rollers to rotate about the axle 40 when in use.

Referring back to FIG. 2, in example embodiments the central axle 40 is a threaded metal rod having a diameter that is preferably at least about ¼ inch in diameter, such that the axle 40 is capable of bending and conforming to a person's contour without breaking. In alternate embodiments, a smooth axle or rod is utilized and in other alternate embodiments, the axle is manufactured from plastic, wood, and/or rubber. The central support axle 40 connects to the distal ends of the handles 20a, 20b by threading at least one nut 42, which is coupled to the distal ends of the handles, over the threaded rod 40—or by other conventional fasteners for securing the same. The at least one nut 42 is coupled to the distal ends of the handles with glue, epoxy, or other conventional fasteners. The interiors of the handles 20a, 20b are also preferably lined with a sleeve or bearing 50. The sleeve 50 can be plastic, metal, and/or other suitable materials.

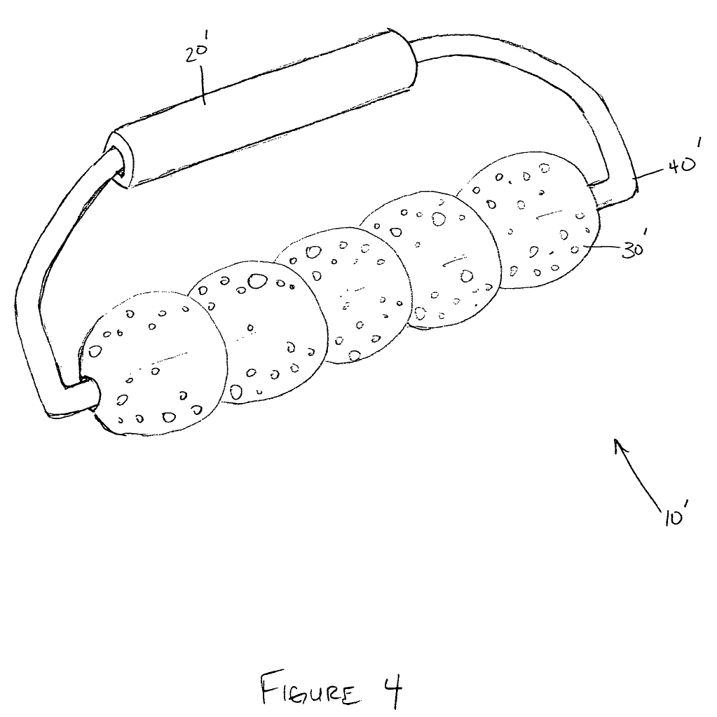

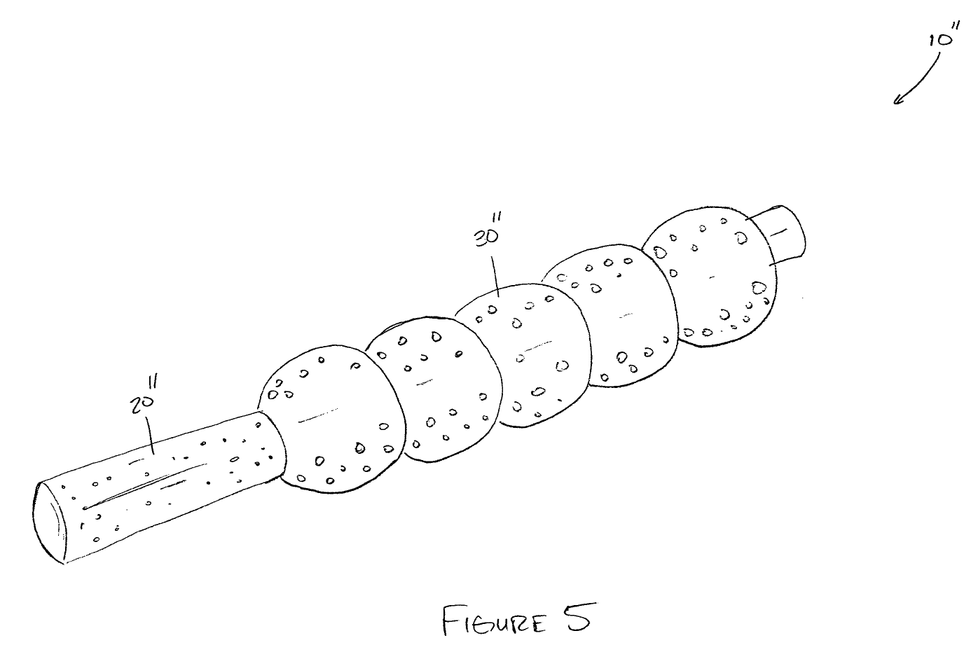

In operation, a user utilizing the massage implement 10 of the present invention can grasp the handles 20a, 20b at the distal ends of the implement and apply the rollers 30 to the muscle or area to be massaged. The user can then apply force to the handles 20a, 20b, which distributes the force to the rollers 30 that are in contact with the area to be massaged. To massage the muscles, a user then moves the rollers back and forth over the area to be massaged, focusing the majority of the force on the center roller 30c. Because of the rounded shape of the rollers 30, a user is able to effectively “dig” into the muscles and alleviate scar tissue, stretch muscle fibers, and increase blood flow to the area in an effective manner. In situations wherein the user wishes to massage a location on his/her body in which two hands are not available for applying pressure, other embodiments of the massage implement 10′,10″ having one handle 20′, 20″ can be used, as seen in FIGS. 4-5. For example, the single handle 20′, 20″ can be an ergonomic gripping handle. In addition to being used on humans, the massage implement 10 of the present invention can also be used to massage animals, such as horses, dogs, cats, etc. The massage implement 10 can be sized to accommodate a particular type of animal, for example, a larger massage implement (being longer and having larger balls or rollers 30) can be used to massage a horse, whereas a smaller implement can be used to massage a dog. It has been found that the massage implement 10 of the present invention is particularly useful in the treatment of horses.

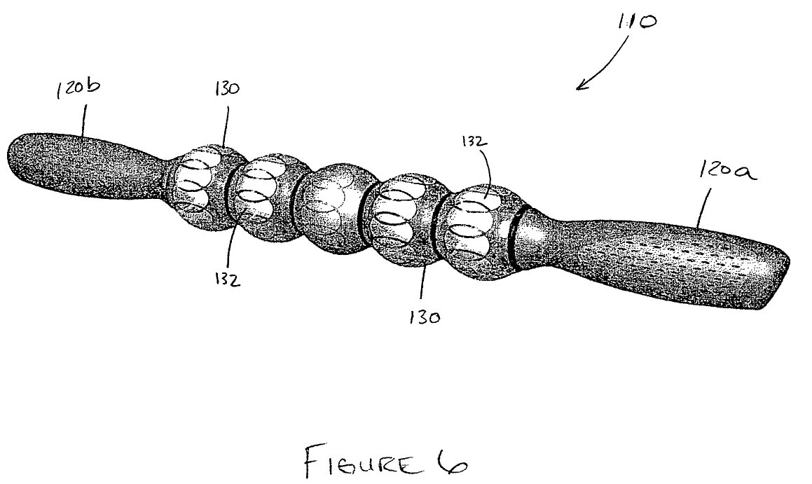

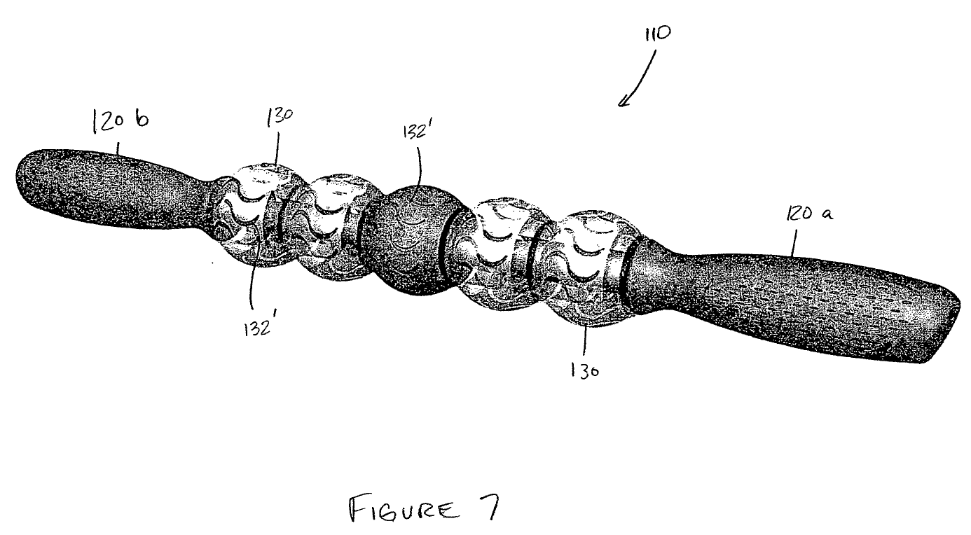

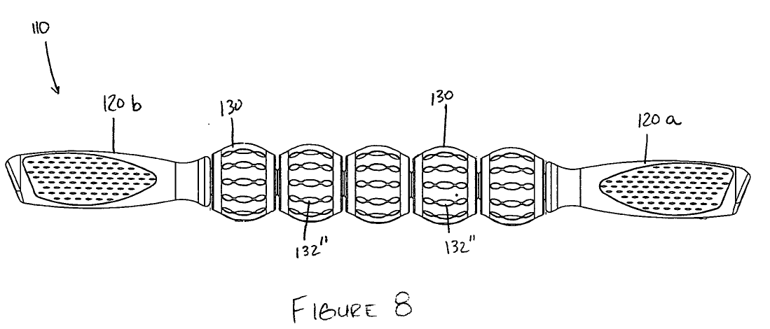

Additional commercial embodiments of the present invention can be seen in FIGS. 6-8. FIG. 6 shows a massage implement 110 having two handles 120a,120b and a plurality of rollers 130. Each roller 130 includes frictional grips 132 protruding from the outside surface of the roller to help rotate the rollers when the implement 110 is engaged and moved about a subject's skin. Alternatively, as seen in FIGS. 7-8, the frictional grips 132′, 132″ can be recessed into the outside surface of the rollers 130. Although FIGS. 6-8 show specific shapes and patterns of grips, in other embodiments the shapes, patterns, and size of the grips 132 can be modified as desired.

While the invention has been described with reference to preferred and example embodiments, it will be understood by those skilled in the art that a variety of modifications, additions and deletions are within the scope of the invention, as defined by the following claims.

What is claimed is:

1. A massage implement comprising:
an elongated central axle;
at least one handle coupled to the central axle; and
a plurality of substantially spherical rollers rotatably coupled to the central axle, each of the rollers being operable to rotate independently of the other rollers.

2. The massage implement of claim 1, wherein the at least one handle includes a first handle and a second handle.

3. The massage implement of claim 2, wherein the first handle is coupled to a first end of the axle and the second handle is coupled to a second end of the axle, and wherein the plurality of rollers are coupled to the axle between the first handle and the second handle.

4. The massage implement of claim 1, wherein the plurality of rollers further comprises five rollers.

5. The massage implement of claim 1, wherein the plurality of rollers are substantially the same size and shape.

6. The massage implement of claim 5 wherein the rollers are approximately the same size as golf balls.

7. The massage implement of claim 1, wherein one or more of the plurality of rollers are larger than the remaining rollers.

8. The massage implement of claim 7, wherein a central roller is the largest roller.

9. The massage implement of claim 1, wherein the rollers comprise frictional grips.

10. The massage implement of claim 1, wherein the rollers comprise dimples.

11. The massage implement of claim 1, wherein the rollers are interchangeable.

12. The massage implement of claim 1, wherein the rollers further comprise bearings.

13. A massage implement for massaging a human or animal subject comprising an elongated rod having a first end and a second end, a first handle coupled at the first end of the rod and a second handle coupled at the second end of the rod, and a plurality of balls rotationally mounted to the rod between the first and second handles.

14. The massage implement of claim 13, wherein each ball is independently mounted to the rod.

15. The massage implement of claim 14, wherein each ball includes bearings.

16. The massage implement of claim 13, wherein each ball includes frictional grips.

17. The massage implement of claim 16, wherein the frictional grips extend from the outer surface of the balls.

18. The massage implement of claim 16, wherein the frictional grips are formed as shallow recesses into the outer surface of the balls.
